(19) United States
(12) Patent Application Publication
(10) Pub. No.: US 2005/0050975 A1
(43) Pub. Date: Mar. 10, 2005

(54) Gear assembly

(76) Inventors: Hirobumi Sasaki, Asaka-shi (JP); Naoto Tokutake, Tokyo (JP); Toru Makino, Tokyo (JP); Toshiro Iwabuchi, Sagamihara-shi (JP); Takahiro Iwasaki, Tokyo (JP); Jun Onishi, Tokyo (JP); Yuichi Ando, Sagamihara-shi (JP)

Correspondence Address: CANTOR COLBURN LLP, 55 Griffin Road South, Bloomfield, CT, 06002, US

(21) Appl. No.: 10/850,900

(22) Filed: May 21, 2004

(30) Foreign Application Priority Data
Sep. 4, 2003 (JP) JP2003-312395

(51) Int. Cl. F16H 1/20

(52) U.S. Cl. 74/413

(57) ABSTRACT

A gear assembly comprises at least two gears, each of which is formed by injection molding and has a plurality of ribs on their bases. The two gears have a gear ratio of 1:N and a ratio of the number of ribs is 1:M (N and M are integers). Alternatively, the two gears are supported in positions where one of ribs on one gear and one of ribs on the other gear lie on the same line at a predetermined number of times while one of gears rotates once. The two gears can also be supported in positions where the ribs on the two gears have predetermined positional relationships so that the two gears rotate at a constant angular speed.

### RELATED APPLICATION

This application is based on Japanese Patent Application No. 2003-312395 filed in Japan on Sep. 4, 2003, the entire content of which is hereby incorporated by reference.

### BACKGROUND OF THE INVENTION

1. Field of the Invention

The present invention relates to a gear assembly that uses a plurality of gears to constitute a gear train and transmits rotational drive force, and an image forming apparatus using this gear assembly.

2. Detailed Description of Related Art

In recent years, there has been an enormous demand for formation of a color image in an image forming apparatus of a copying machine or printer. To form a high-quality color image in the color image forming apparatus, it is essential to improve the precision of color registration where images of image of cyan, magenta, yellow and black are overlaid without misregistration.

In the meantime, the gears used to drive a photoconductor and intermediate transfer section or the like employed in the image forming apparatus is commonly manufactured by injection molding using synthetic resins. In the production of a gear by injection molding, the tooth profile of an actually manufactured gear has an error with respect to the designed tooth profile. By way of an example, FIG. 2 shows an actual tooth profile error with respect to a reference involute tooth profile according to JIS B1701. If a gear containing an error is used to drive the photoconductor or intermediate transfer section or the like, fluctuation will occur to the rotation of the photoconductor or intermediate transfer section. This will result in a color misregistration in the image that is formed without a predetermined level of precision achieved in color registration. If an attempt is made to produce a high-precision gear by injection molding in an effort to solve this problem, the molding die must be manufactured to an extremely high precision or the molding method must be improved, with the result that production costs will be raised.

The Japanese Application Patent Laid-Open Publication No. 2001-124152 proposes a less expensive gear apparatus capable of ensuring high driving performances using the gear produced by conventional injection molding. In this example, attention is paid to the gate through which a die is charged with resin at the time of injection molding, and the configuration is so arranged in the combination of injection molding gears that the gates will face each other at the position of gear engagement. In the meantime, to improve the gear strength, gears are often provided with ribs. The method proposed in this method completely ignores the gear equipped with rib.

### SUMMARY

In view of the aforementioned prior arts, one of the objects of the present invention is to provide an improved version of a gear assembly.

Another object of the present invention is to provide a gear assembly capable of transmitting high-precision drive using the gear produced by injection molding.

These objects can be attained by providing a gear assembly arranged as follows:

A gear assembly comprises at least two gears, each of which is formed by injection molding and has a plurality of ribs on their bases. The two gears have a gear ratio of 1:N and a ratio of the number of ribs is 1:M (N and M are integers). Alternatively, the two gears are supported in positions where one of ribs on one gear and one of ribs on the other gear lie on the same line at a predetermined number of times while one of gears rotates once. The two gears can also be supported in positions where the ribs on the two gears have predetermined positional relationships so that the two gears rotate at a constant angular speed.

The invention itself, together with further objects and attendant advantages, will best be understood by reference to the following detailed description taken in conjunction with the accompanying drawings.

### BRIEF DESCRIPTION OF THE DRAWINGS

FIG. 1 is a cross sectional view representing a color image forming apparatus;

FIG. 2 is a drawing representing a gear tooth profile;

FIG. 3(a) and 3(b) each is a drawing representing one example of the result of measuring gear engagement;

FIGS. 4(a) to 4(c) each is a drawing representing another example of the result of measuring gear engagement;

FIGS. 5(a) and 5(b) each is a drawing representing an example of matching the phases of two adjacent gears;

FIG. 6 is a drawing representing an example of a ground gear arranged at some midpoint;

FIGS. 7(a) to 7(c) each is a drawing showing an example of a gear train consisting of three or more gears;

FIG. 8 is a cross sectional view of a color image forming apparatus of a configuration different from that of FIG. 1;

FIG. 9 is a drawing showing a drive transmission apparatus of the intermediate transfer section of FIG. 1; and

FIG. 10 is a drawing representing a drive transmission apparatus of the transfer belt apparatus of FIG. 9.

In the following description, like parts are designated by like reference numbers throughout the several drawings.

### DETAILED DESCRIPTION OF THE PREFERRED EMBODIMENTS

The following shows an example of applying the gear assembly of the present invention to a color image forming apparatus.

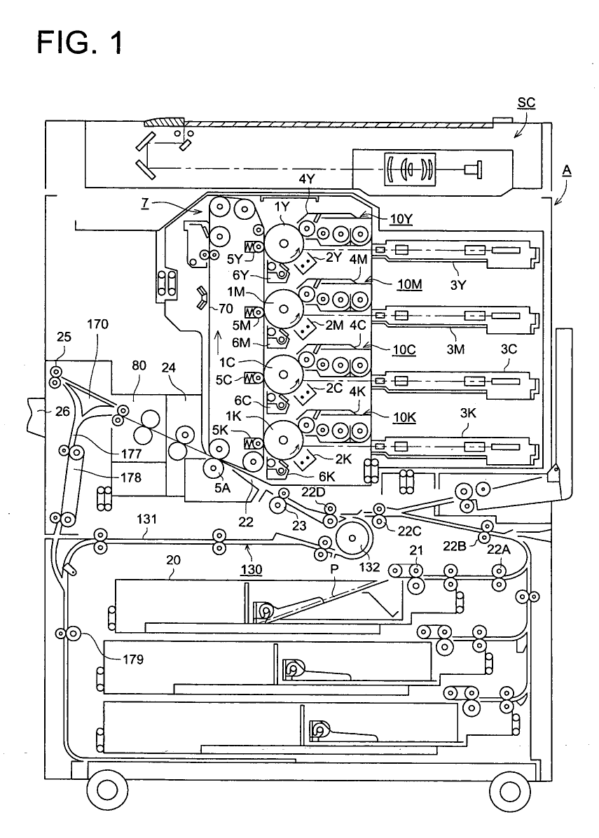

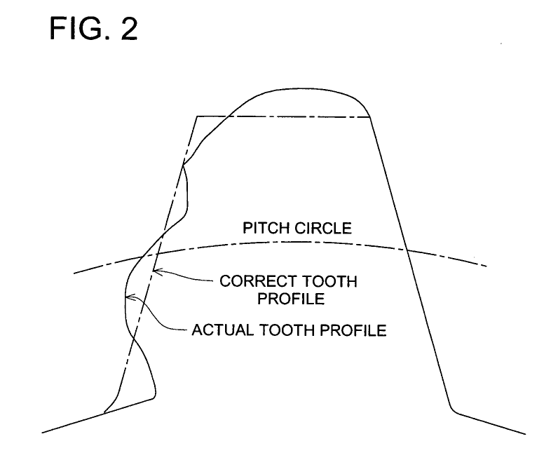

FIG. 1 is a cross sectional view representing a color image forming apparatus. This color image forming apparatus is what is called a tandem-type color image forming apparatus. It consists of an image forming section 10Y for forming an yellow image, an image forming section 10M for forming a magenta image, an image forming section 10C for forming a cyan image, an image forming section 10K for forming a black image, an intermediate transfer unit 7 equipped with an endless belt-like intermediate transfer section 70, paper supply/feed apparatus and a fixing apparatus 24. A document image scanner SC is arranged on the top of the main unit A of the image forming apparatus.

Each of the image forming sections 10 comprises a drum-like photoconductor 1 as an image carrier, a charging device 2 arranged around this photoconductor 1, an exposure apparatus 3, a developing apparatus 4, primary transfer rollers 5 as primary transfer apparatuses and a cleaning apparatus 6. The toner image of various colors formed by image forming sections 10Y, 10M, 10C and 10K is transferred sequentially onto the rotating endless belt-like intermediate transfer section 70 by the primary transfer rollers 5Y, 5M, 5C and 5K as primary transfer apparatuses, whereby a composite color image is formed.

The transfer material P as a recording medium accommodated in the image transfer section 20 is fed by a paper supply apparatus 21, and is then fed to the secondary transfer apparatus 5A via a plurality of intermediate rollers 22A, 22B, 22C and 22D. Color images are collectively transferred onto the transfer material P. The transfer material P on which the color image has been transferred is fixed by the fixing apparatus 24. Depending on the case, it is sandwiched by an ejection roller 25 after traveling through a curl straightening device 80 located downstream, and is ejected onto the ejection tray 26.

When an image is formed on both sides of the transfer material P, an ejection switching member 170 is switched and a paper guide 177 is released. The transfer material P is fed in the direction marked by an arrow of broken line and is transported downward by a transport device 178. It is switched back by a paper reversing device 179, and the trailing end of the transfer material P is turned into a leading edge, with the result that the transfer material P is transported into a paper supply unit 130 for double-sided copying. The transfer material P moves a transport guide 131 arranged in the paper supply unit 130 for double-sided copying, in the direction where the paper is supplied. Paper is again supplied by a paper feed roller 132, and is guided to a transfer path 22. The transfer material P is again transported to the secondary transfer position, and a toner image is transferred onto the back surface of the transfer material P. After fixing has been completed by the fixing apparatus 24, the transfer material P is ejected to the ejection tray 26.

In the present embodiment, the gears manufactured by injection molding are used to drive the photoconductor 1 and intermediate transfer section 70. The following describes the combination of the injection molded gears. In the color image forming apparatus, all gear ratios in the gear train is usually integers from the viewpoint of color registration.

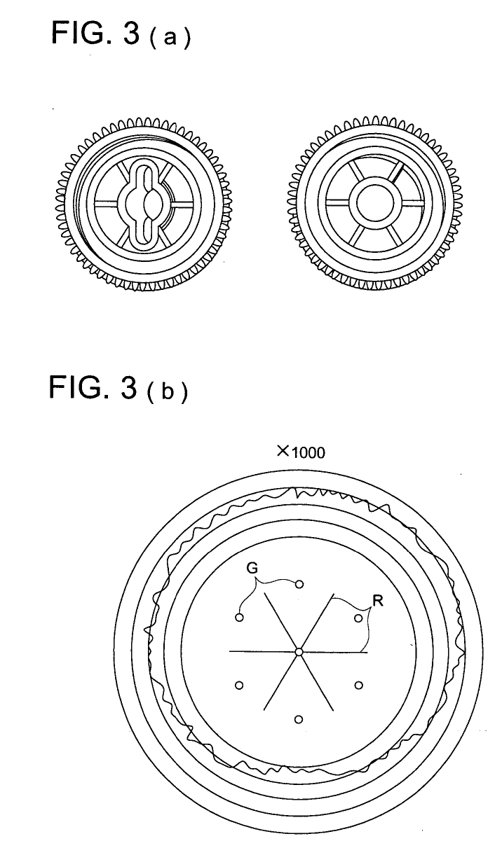

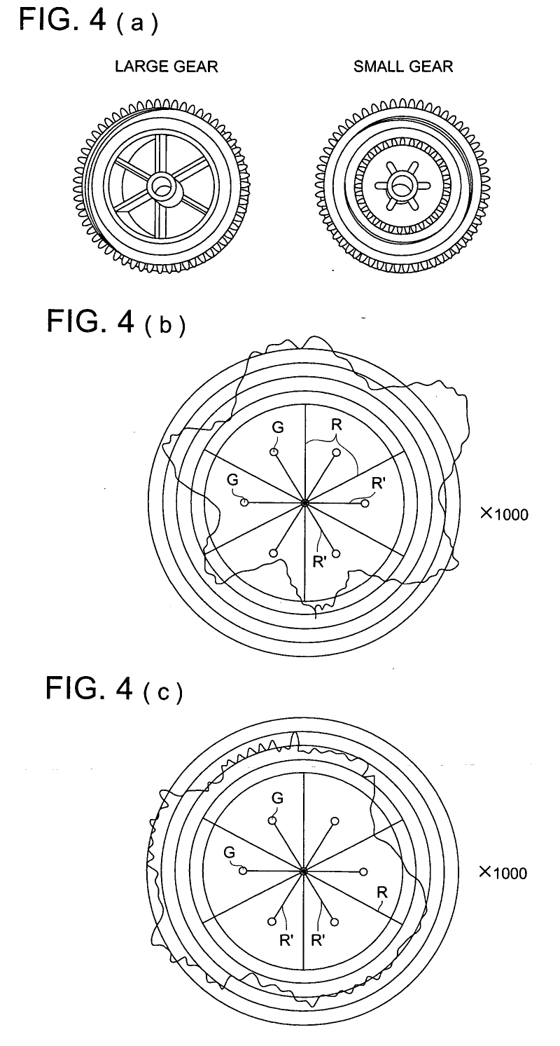

To check the gears manufactured by injection molding, gear engagement was measured according to the Standard JGMA116-02 of Japan Gear Manufacturers Association. It has been verified that there is a flower petal-like shape having a convex portion and concave portion as shown in FIGS. 3(b) and 4(b) and 4(c). In this measurement, a gear to be tested was engaged with a master gear for inspection without backlash, and fluctuation in the center-to-center distance of the gears was measured while driving the gears.

FIG. 3 shows a gear with theeth formed on the outermost periphery. FIG. 4 shows a gear where a large gear is formed on the outermost periphery and a small gear on the inside. The (a)'s show the front and back surfaces, respectively. The (b) and (c) show the profile of gear errors. “R” denotes the rib position, and “G” the gear gate position. FIG. 4 uses R and R′ to denote the positions of the ribs of large and small gears. FIG. 4(b) shows the profile of large gear errors, while FIG. 4(c) exhibits the profile of small gear errors. It is possible to infer from these drawings that the phase of the error profile corresponds to the flow of the resin based on the rib position.

To put it another way, a die is charged with resin through the gate of the die at the time of injection molding, so the charged resin flows into the peripheral portion of the gear along the rib portion. Thus, the diameter of the gear produced tends to be greater on the rib portion, and smaller on the portion intermediate between the ribs. This makes it difficult to achieve a predetermined roundness of the gear. If such a gear is used to drive the photoconductor and intermediate transfer section or the like, a fluctuation in drive speed will result.

In other words, if the gear diameter is uneven and a variation is found in the peripheral direction, the peripheral speed of the gear (linear speed) fluctuates in the peripheral direction, despite constant gear drive speed (angular speed), causing fluctuation of the drive speed of another gear meshing with this gear. The fluctuation in the gear drive speed is ultimately represented as deterioratio in color registration.

In the present embodiment, a constant peripheral speed in the entire gear train is obtained by matching the phases of the error profiles of gears (convex and convex; concave and concave).

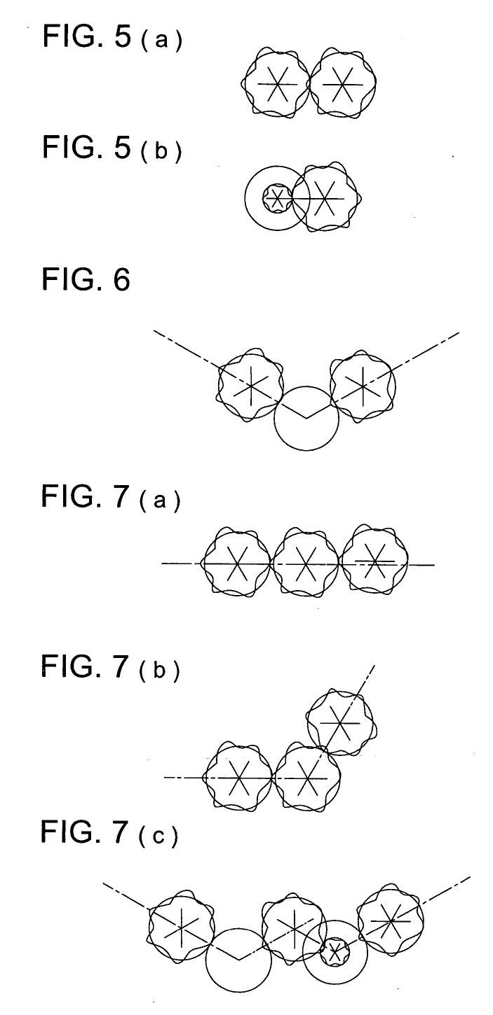

To put it more specifically, FIG. 5 shows an example of matching the phases of two adjacent gears for injection molding. Each gear has six ribs and injection molding is performed through six gates. In this case, as described above, the waveform of the error profile of the gear is shaped like six flower petals in conformity to rib positions by the flow of the resin at the time of injection molding. Either of the gears has six ribs, and a ratio of the number of ribs is 1 (=integer). FIG. 5 shows only the case where each of the gears has six ribs. Sufficient effects can be gained if it is possible to ensure the ratio of the number of ribs is an integer (or an integral submultiple), for example, when each of them has four ribs, or one of them has four ribs while the other has eight.

FIG. 5(a) shows the case when the gear ratio of the adjacent gears is 1:1 (gear ratio=1). In this case, it is possible to adjust the phases at the positions of convex and convex→concave and concave→convex and convex→concave and concave. Work is very simple at the time of assembling; namely, only arrangement work is necessary to ensure that rib positions will face each other. The gear ratio is 1 and the ratio of the number of ribs is 1; therefore, both ribs are arranged on the same line six times during one rotation of the gear.

FIG. 5(b) shows the case where the gear ratio is 1:2 (gear ratio=2). If the gears are engaged with each other based on the reference of the convex-and-convex position, the phase is adjusted at the positions of convex and convex concave and halfway→convex and concave→concave and halfway→convex and convex. In this case, only work required at the time of assembling is the arrangement work to ensure that ribs face each other. Since the gear ratio is 2 and the ratio of the number of ribs is 1, both ribs are arranged on the same line three times during one rotation of the small gear. If the ratio of the number of ribs is 2 (i.e. the number of ribs of small gear: that of large gear=1:2), convex portions of the two gears are engaged with each other or concave portions of the two gears are engaged with each other without exception. This ensures a gear train of higher precision.

Incidentally, when the gear ratio is 1:3 (gear ratio 3), if the gears are engaged with each other based on the reference of the convex-and-convex position, the phase is adjusted at the positions of convex and convex→concave and halfway→convex and halfway→concave and concave→convex and halfway→concave and halfway convex and convex. In this case, since the gear ratio is 3 and the ratio of the number of ribs is 1, both ribs are arranged on the same line only twice during one rotation of the small gear. In this example, the gear train drive precision is slightly reduced as compared with the case where convex portions of the two gears are engaged with each other or concave portions of the two gears are engaged with each other without exception. However, the precision is clearly high as compared to the case where no phase matching is performed.

FIG. 6 shows the case where a ground gear whose engagement error is removed by grinding is installed halfway between the gears used in FIG. 5. Phase matching is performed between injection molded gears on both sides, with the ground gear sandwiched in-between. When the ground gear is sandwiched, the fluctuation in peripheral speed can be controlled by matching the phase of injection molded gears. In this example, the gear train is arranged at an angle of 120 degrees. In this case, the predetermined effect can be obtained by making arrangement in such a way that each of the ribs on the injection molded gears on both ends faces the center of the ground gear.

FIG. 7 shows an example of forming a gear train using three or more injection molded gears. FIG. 7(a) shows the example where the injection molded gears are arrangement in a line. FIG. 7(b) shows the example where the engagement position of the injection molded gears on the right end is displaced 60 degrees from other gear train so that the angle of the gear train is 20 degrees. FIG. 7(c) shows the example where a ground gear is installed halfway and the gears having a gear ratio of 1:2 are combined, with the engagement position displaced 60 degrees. Thus, three gear trains having an angle of 120 degrees are formed. All of the examples shown above are the result of applying the gear train described with reference to FIG. 5 or 6. Gears are arranged in such a way that mutually adjacent gears (gears on both ends if a ground gear is sandwiched in-between) will meet the aforementioned relationship.

As described with reference to FIGS. 5 through 7, the waveform of the error profile is determined by the rib position. Thus, easy gear assembling can be achieved if the rib position of each gear is used as a reference when assembling the gear train.

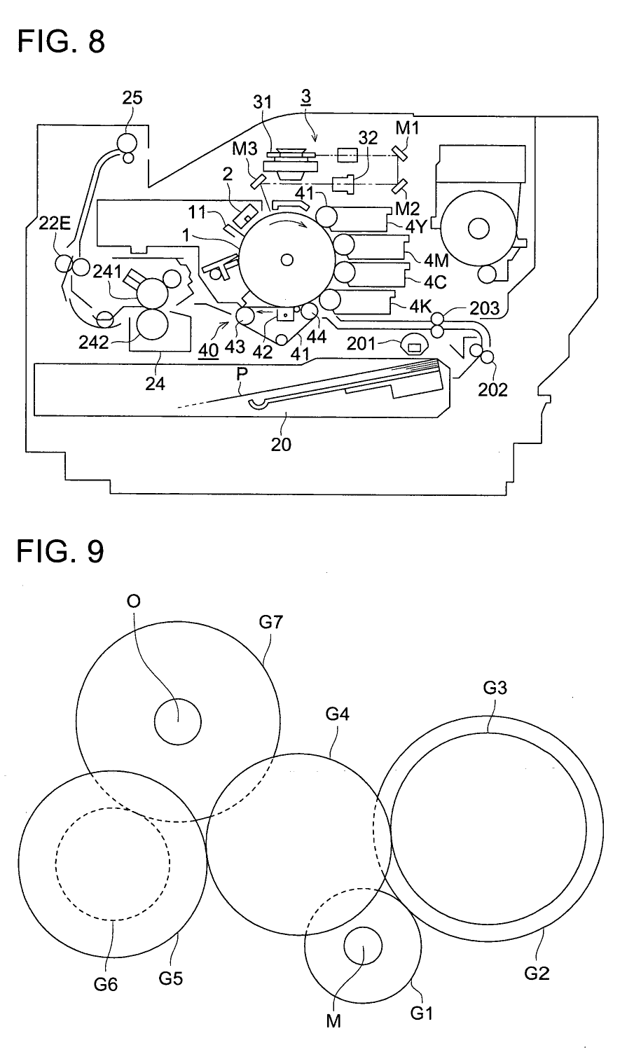

FIG. 8 is a cross sectional view of a color image forming apparatus of a different type.

In FIG. 8, numeral 1 denotes a photoconductor drum having, for example, an OPC photoconductor on the periphery. It is driven in the clockwise direction in the grounded state. Numeral 2 denotes a Scorotron charging device, where the photoconductor 1 is uniformly changed by corona discharge using a grid maintained at predetermined voltage and a discharge wire, thereby giving a predetermined voltage. Prior to charging by the Scorotron charging device 2, the photoconductor is subjected to electric charge elimination in advance by the exposure of the pre-charging exposure lamp (PCL) 11 in order to remove the hysteresis of the photoconductor.

After charging of the photoconductor 1, image exposure based on the image signal is started by a laser write apparatus 3. After the image signal corresponding to the colors outputted from the computer or image scanner has been processed by the image signal processor, it is inputted into the laser write apparatus 3, and the aforementioned image exposure is sequentially carried out on the photoconductor drum 1, thereby forming a latent image corresponding to each color. The laser write apparatus, using a laser diode (not illustrated) as a light source, provides main scanning of image exposure on the drum surface via a rotating polygon mirrors 31 and fq lens 32 through reflective mirrors M1, M2 and M3. A latent image is formed by sub-scanning accompanying the rotation of the drum.

Developing apparatuses 4Y, 4M, 4C and 4K accommodating toner yellow (Y), magenta (M), cyan (C) and black (K), and a developer consisting of magnetic carrier are provided on the peripheral surface of the photoconductor drum 1. When a yellow (Y) latent image has been formed, the developing apparatus 4Y accommodating the yellow (Y) developer is driven. Then when a magenta (M) latent image has been formed, the developing apparatus 4M accommodating magenta (M) developer is driven. In the same manner, the developing apparatus 4C and 4K are driven every time each latent image has been formed, and non-contact development is carried out. Thus, toner images of various colors are overlaid, and a color toner image is formed on the drum. The aforementioned development corresponds to so-called non-contact development wherein development sleeves 41 carrying the developer are placed at predetermined intervals with respect to the drum surface, and development is performed in the non-contact state. In the phase of development, development bias voltage with direct current and alternating current superimposed thereon is applied between the development sleeve 41 and photoconductor drum 1, and the toner containing in the developer on the development sleeve 41 is sent flying toward the latent image. Thus, the image is made visible as toner is kept in close contact with the portion of latent image.

In the meantime, the transfer material P is transported to the timing roller 203 from the semicircular roller 201 by the operatio of a transport roller 202 and paper supply cassette 20. Synchronized with the toner image on the photoconductor drum 1, the transfer material P is sent to the transfer belt apparatus 40.

The transfer belt apparatus 40 comprises a transfer belt 41 stretched between a pulley 43 and pulley 43 and transfer electrode 42, wherein the transfer material P is transported in the counterclockwise direction in circulation at the same speed as the peripheral surface of the photoconductor drum 1 by the rotation of the roller. The transfer material P is transported in the state sandwiched between the pressurized surface and the peripheral surface of the drum, and the toner image on the drum is transferred to the transfer material P. The transfer belt apparatus 40 is pressed against the peripheral surface of the drum at the time of transfer. When transfer is not performed, the pulley 44 rotates about the pulley 43 in the clockwise direction, and the transfer belt 41 is kept non-contact state with respect to the peripheral surface of the photoconductor drum 1.

The transfer material P with the toner image transferred thereto is separated from the peripheral surface of the photoconductor drum 1 and is transported to the fixing apparatus 24. While being transported in the state sandwiched between a heating roller 241 and rip roller 242, the transfer material P melts toner and is ejected onto the upper portion of the apparatus through a transfer roller 22E and paper ejection roller 25.

In parallel to the aforementioned steps, the photoconductor drum 1 separated from the transfer material P is cleaned by the blade 61 of a cleaning apparatus 6 placed in mechanical contact, with its remaining toner removed by this blade. Then the system goes to the next step of image formation.

In the image forming apparatus shown in FIG. 1, the intermediate transfer section 70 was driven by the drive system shown in FIG. 9, to evaluate the fluctuation of the traveling speed of the intermediate transfer section with the photoconductors 1Y, 1M, 1C and 1K placed in mechanical contact.

In FIG. 9, the drive force of the drive shaft M of the motor is transmitted to the output shaft O through gears G1, G2, G3, G4, G5, G6 and G7 in that order, where the output shaft O serves as the shaft of the drive roller of the intermediate transfer section 70. In this gear train, the gear G4 is a ground gear and the gears G3 and G5 are injection-molded gears with six ribs and six gates. Under this condition, seven experiments were conducted by replacing the gears used as G3 and G5 in the following two cases: (1) when the gears G3 and G5 were engaged at the phase adjusted condition in which ribs on the two gears face each other, and (2) when the gears G3 and G5 were engaged at the phase shifted condition in which ribs on the two gears were displaced 30 degrees. The following describes the results of these experiments:

| Experiment No. | | Speed fluctuation (%) |
|---|---|---|
| 1 | Phase adjusted | 0.38 |
| | Phase shifted | 0.90 |
| 2 | Phase adjusted | 0.36 |
| | Phase shifted | 0.38 |
| 3 | Phase adjusted | 0.55 |
| | Phase shifted | 1.20 |
| 4 | Phase adjusted | 0.67 |
| | Phase shifted | 1.26 |
| 5 | Phase adjuted | 0.22 |
| | Phase shifted | 0.78 |
| 6 | Phase adjusted | 0.37 |
| | Phase shifted | 1.12 |
| 7 | Phase adjusted | 0.45 |
| | Phase shifted | 1.10 |

This shows that fluctuation in drive speed on the output side can be reduced if at least one set of the gears constituting the gear train is configured so that gear engagement is carried out in adjusted phase, as described above.

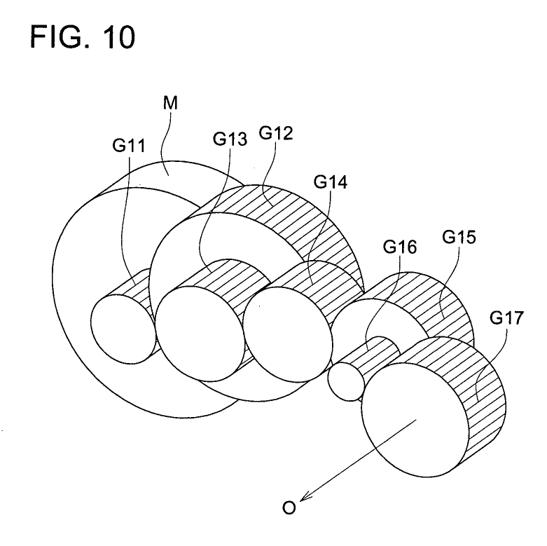

Further, the drive system of the transfer material transport apparatus (transfer belt apparatus 40) of the image forming apparatus shown in FIG. 8 was configured as shown in FIG. 10, and image formation was performed. This test has revealed that there is no uneven pitch despite continuous image formation of multiple sheets. It should be noted that, in FIG. 10, the drive force of the drive shaft of the motor M is transmitted to the output shaft O through the gears G11, G12, G13, G14, G15, G16, and G17 in that order, where the output shaft O serves as the shaft of the drive roller of the transfer belt apparatus 40. In FIG. 8, each gear has six ribs, and has been manufactured by injection molding through six gates. Gears G13 through G15 are engaged with each other where the phase is adjusted at the positions of convex and convex→concave and concave→convex and convex→concave and concave. The G16 and G17 are engaged with each other where the phase is adjusted at the positions of convex and convex→concave and halfway→convex and concave→concave and halfway→convex and convex.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1. A gear assembly comprising:
at least two gears, each of which is formed by injection molding and has a plurality of ribs on their bases, said two gears having a gear ratio N and a ratio of the number of ribs being 1:M, wherein N and M are integers.

2. A gear assembly claimed in claim 1, wherein N and M are the same number.

3. A gear assembly claimed in claim 1, wherein the assembly is used for a driving device in an image forming apparatus.

4. A gear assembly claimed in claim 3, wherein the image forming apparatus is a color image forming apparatus.

5. A gear assembly claimed in claim 4, wherein the color image forming apparatus is a tandem-ype color image forming apparatus.

6. A gear assembly claimed in claim 1, wherein one of the ribs on the one gear faces one of the ribs on the other gear.

7. A gear assembly comprising:
at least two gears, each of which is formed by injection molding and has a plurality of ribs on their bases, said two gears being supported in positions where one of ribs on one gear and one of ribs on the other gear lie on the same line at a predetermined number of times while one of gears rotates once.

8. A gear assembly as claimed in claim 7, wherein, if three or more gears are arranged, the adjacent gears meet the relationship mentioned in claim 7.

9. A gear assembly as claimed in claim 8, wherein three or more gears are arranged in a straight line.

10. A gear assembly as claimed in claim 7, wherein, when a gear formed by grinding is installed between injection molded gears, the adjacent gears sandwiching the ground gear meets the relationship mentioned in claim 7.

11. A gear assembly claimed in claim 7, wherein the assembly is used for a driving device in an image forming apparatus.

12. A gear assembly claimed in claim 11, wherein the image forming apparatus is a color image forming apparatus.

13. A gear assembly claimed in claim 12, wherein the color image forming apparatus is a tandem-type color image forming apparatus.

14. A gear assembly comprising:
at least two gears, each of which is formed by injection molding and has a plurality of ribs on their bases, said two gears being supported in positions where the ribs on the two gears have predetermined positional relationships so that the two gears rotate at a constant angular speed.

15. A gear assembly as claimed in claim 14, wherein, if three or more gears are arranged, the adjacent gears meet the relationship mentioned in claim 14.

16. A gear assembly as claimed in claim 14, wherein, when a gear formed by grinding is installed between injection molded gears, the adjacent gears sandwiching the ground gear meets the relationship mentioned in claim 14.

17. A gear assembly claimed in claim 14, wherein the assembly is used for a driving device in an image forming apparatus.

18. A gear assembly claimed in claim 17, wherein the image forming apparatus is a color image forming apparatus.

19. A gear assembly claimed in claim 18, wherein the color image forming apparatus is a tandem-type color image forming apparatus.
